(19) United States
(12) Patent Application Publication
(10) Pub. No.: US 2011/0154061 A1
(43) Pub. Date: Jun. 23, 2011

(54) DATA SECURE MEMORY/STORAGE CONTROL

(76) Inventors: Babu CHILUKURI, Cupertino, CA (US); Amjad Qureshi, San Jose, CA (US)

(21) Appl. No.: 12/642,869

(22) Filed: Dec. 21, 2009

(51) Int. Cl. G06F 12/14; H04L 9/00

(52) U.S. Cl. 713/193; 380/277; 711/163; 711/E12.092

(57) ABSTRACT

A method includes encrypting, in a security engine associated with a memory/storage controller of a memory/storage device in a data processing device, a pre-encrypted/unencrypted data stream associated with a multimedia content in accordance with a data write request to transfer the pre-encrypted/unencrypted data stream to the memory/storage device using a security key configured to uniquely identify the data processing device during each data write session and a security flag configured to uniquely identify each data write session during a secure mode of operation. The method also includes transmitting the security engine encrypted data stream to the memory/storage device in accordance with the data write request, and decrypting the security engine encrypted data stream using the security key and the security flag in accordance with a data read request to read the security engine encrypted data stream stored in the memory/storage device.

### FIELD OF TECHNOLOGY

This disclosure relates generally to data security and, more particularly, to a method, an apparatus, and a system to realize data secure memory/storage control in data processing devices.

### BACKGROUND

Data security in multimedia (e.g., text, image, audio, and video) processing devices is of paramount importance. For example, playing media (e.g., video) on media processing devices (e.g., a Personal Computer (PC), a mobile phone) may involve transferring a data stream associated with the media content to a memory on/off the media processing device prior to rendering the media content on the media processing device. When standard encryption schemes may be utilized to encrypt the media content, the security keys and flags associated with the encryption may also be transferred to the memory, along with the data stream associated with the media content. The standard encryption schemes may be based on traditional algorithms that are well understood.

FIG. 1 shows a data processing device 100. The data processing device 100 may include a memory/storage controller 102 configured to control a data write request and a data read request to a memory/storage device 104 in the data processing device 100. The data write request and the data read request may be initiated by, say, a processor in the data processing device 100. When a data write request (e.g., write data 110) is initiated, a data stream associated with a media content may be encrypted in the encryption module 106 prior to being transferred to the memory/storage device 104 through the memory/storage controller 102.

When a data read request (e.g., read data 112) is initiated, the encrypted data stream stored in the memory/storage device 104 may be decrypted at the decryption module 108 prior to being rendered on, say, a display unit or a media player in the data processing device 100. The encryption module 106 and the decryption module 108 may constitute the security engine 150 associated with the memory/storage controller 102, as shown in FIG. 1.

When standard algorithms may be employed during the encryption process, a potential hacker may figure out the security keys associated with the encryption process to enable separation of the actual data content from the security key stored in the memory/storage device 104. Moreover, in an open architecture such as a PC architecture or an open operating system (e.g., Linux™, Android™), a potential hacker may have a byte-by-byte access to the memory/storage device 104, and may dump the contents of the memory/storage device 104 as per his/her convenience. Then, the hacker may potentially reverse engineer the security keys and the associated data.

The data security in the data processing device 100 may, therefore, be compromised.

### SUMMARY

Disclosed are a method, an apparatus, and a system to realize data secure memory/storage control in data processing devices.

In one aspect, a method includes encrypting, in a security engine associated with a memory/storage controller of a memory/storage device in a data processing device, a pre-encrypted/unencrypted data stream associated with a multimedia content in accordance with a data write request to transfer the pre-encrypted/unencrypted data stream to the memory/storage device using a security key configured to uniquely identify the data processing device during each data write session and a security flag configured to uniquely identify each data write session during a secure mode of operation.

The method also includes transmitting, using the memory/storage controller, the security engine encrypted data stream to the memory/storage device in accordance with the data write request, and decrypting, in the security engine associated with the memory/storage controller, the security engine encrypted data stream using the security key and the security flag utilized during the data write session associated with the encryption of the pre-encrypted/unencrypted data stream and the transfer of the security engine encrypted data stream to the memory/storage device in accordance with a data read request to read the security engine encrypted data stream stored in the memory/storage device.

In another aspect, a method includes generating, in a security engine associated with a memory/storage controller of a memory/storage device in a data processing device, a security key configured to uniquely identify the data processing device, and encrypting, in the security engine associated with the memory/storage controller, a pre-encrypted/unencrypted data stream associated with a multimedia content in accordance with a data write request to transfer the pre-encrypted/unencrypted data stream to the memory/storage device using the security key configured to uniquely identify the data processing device during a secure mode of operation.

The method also includes uniquely identifying the data write session associated with the data write request using a security flag generated in the security engine to enable subsequent decryption of the security engine encrypted data stream using the security key and the security flag in accordance with a data read request to the memory/storage device, and generating a new security key configured to uniquely identify the multimedia processing device during a subsequent data write session.

In yet another aspect, a data processing device includes a memory/storage device, a memory/storage controller configured to control a data read request and a data write request to the memory/storage device, and a security engine associated with the memory/storage controller. The security engine is configured to encrypt a pre-encrypted/unencrypted data stream associated with a multimedia content in accordance with the data write request to transfer the pre-encrypted/unencrypted data stream to the memory/storage device based on a security key and a security flag generated therein. The security key is configured to uniquely identify the data processing device during each data write session, and the security flag is configured to uniquely identify each data write session.

The security engine is also configured to decrypt the security engine encrypted data stream using the security key and the security flag utilized during the data write session associated with the encryption of the pre-encrypted/unencrypted data stream and the transfer of the security engine encrypted data stream to the memory/storage device in accordance with the data read request to read the security engine encrypted data stream stored in the memory/storage device.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a system view of a data processing device.

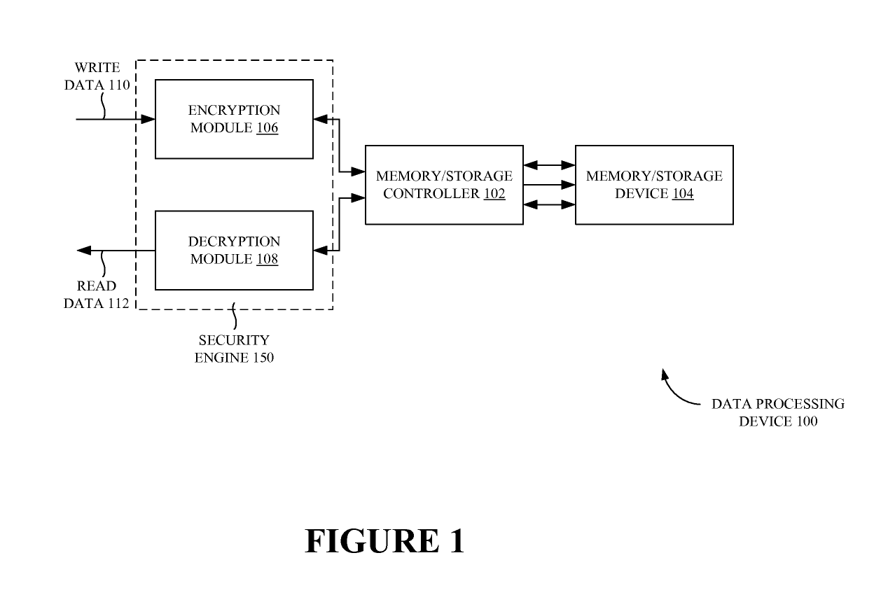

FIG. 2 is system view of a data processing device including a data secure memory/storage control system, according to one or more embodiments.

FIG. 3 is a flowchart detailing the operations involved in a write data process, according to one or more embodiments.

FIG. 4 is a flowchart detailing the operations involved in a read data process, according to one or more embodiments.

FIG. 5 is a process flow diagram detailing the operations involved in a method of securely encrypting/decrypting a data stream, according to one or more embodiments.

FIG. 6 is a process flow diagram detailing the operations involved in a data secure memory/storage control, according to one or more embodiments.

Other features of the present embodiments will be apparent from the accompanying drawings and from the detailed description that follows.

### DETAILED DESCRIPTION

Example embodiments, as described below, may be used to realize data secure memory/storage control in data processing devices. Although the present embodiments have been described with reference to specific example embodiments, it will be evident that various modifications and changes may be made to these embodiments without departing from the broader spirit and scope of the various embodiments.

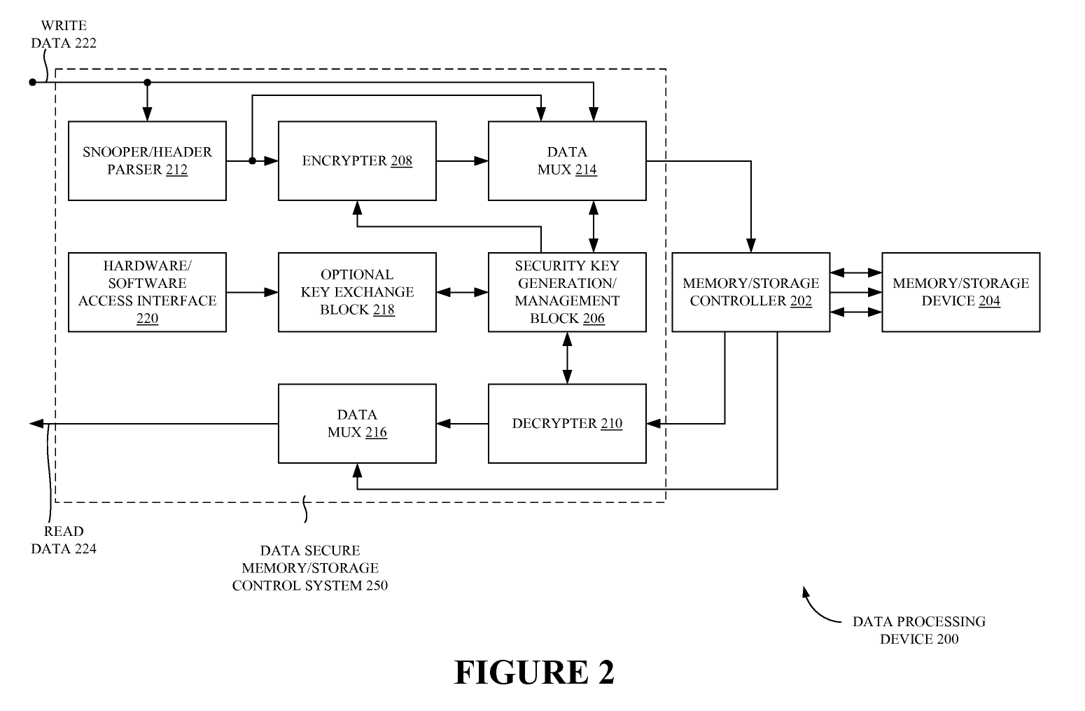

FIG. 2 shows a data secure memory/storage control system 250 in a data processing device 200, according to one or more embodiments. In one or more embodiments, the data processing device 200 (e.g., a Personal Computer (PC), a mobile phone, a set-top box) may include a memory/storage controller 202 configured to control memory/storage device 204. In one or more embodiments, the memory 204 may be an on-chip memory and/or an off-chip memory, or a virtual memory. In one or more embodiments, the memory 204 may be a Static Random Access Memory (SRAM), Register Files, a Non-volatile Random Access Memory (NVRAM), a Dynamic Random Access Memory (DRAM), a cache memory, a Double Data Rate (DDR) memory, register files, a Content Comparator Memory (CCM), a data memory, a Closely Coupled Memory and/or a Large First-In First-Out (FIFO) memory. In one or more embodiments, the storage device 204 may be a hard disk drive and/or a flash disk drive, or a virtual storage device.

In one or more embodiments, the memory controller 202 may be a Double Data Rate-1 (DDR1) controller, Double Data Rate-2 (DDR2) controller, Double Data Rate-3 (DDR3) controller or a Rambus® memory controller. In one or more embodiments, the memory controller 202 may be compatible with all current and future Double Data Rate (DDR), Graphics Double Data Rate (GDDR) and/or Rambus® DRAM (RDRAM) standards. In one or more embodiments, the memory/storage controller 202 may interface data associated with external requests (e.g., write data 222 to memory/storage device 204, and read data 224 from memory/storage device 204) to the memory/storage device 204. In one or more embodiments, during a secure mode of operation, the data secure memory/storage control system 250 may be configured to encrypt a data stream associated with a multimedia (e.g., text, image, audio, video) content to be processed (e.g., rendered on a display unit) on the data processing device 200 based on a device-specific security key generated by the security key generation/management block 206 of the data secure memory/storage control system 250.

In one or more embodiments, the security key may be different for different data processing devices 200, i.e., the security key may be based on a device-specific identifier. In one or more embodiments, the security key may be based on a random number generator within the security key generation/management block 206. In one or more embodiments, the security key may change every time the data processing device 200 is powered up, i.e., a new random number may be generated every time the data processing device 200 is powered up. In one or more embodiments, the data secure memory/storage control system 250 may also provide for a security key refresh mechanism through the security key generation/management block 206, where the refresh mechanism may be based on several factors (e.g., temperature, duration of the ON state, number of data transfer cycles etc.). In other words, in one or more embodiments, the security key may be periodically refreshed to provide an additional layer of security.

In one or more embodiments, the unique device-specific security key may be based on the manner of powering-up of the data processing device 200, which depends on factors such as operating voltage, process variation, and temperature. In one or more embodiments, once the security key and the write data 222 request are generated, the security key may be stored in the security key generation/management block 206, along with a security flag, which serves as an indicator of the data write session. In one or more embodiments, the security key and the security flag may be unique to a data write session. In one or more embodiments, the security key and the security flag may be stored in a secure buffer of the security key generation/management block 206. In one or more embodiments, when a storage controller 202 is used to control a storage device 204, the security key and the security flag may be stored in a non-volatile memory (not shown in FIG. 2) associated with the security key generation/management block 206. In one or more embodiments, the non-volatile memory may be a part of the security key generation/management block 206. In one or more embodiments, the non-volatile memory may be a Read-Only Memory (ROM).

In one or more embodiments, therefore, the data stream associated with media content may be further encrypted prior to the transfer thereof to the memory/storage device 204 through the memory/storage controller 202. In one or more embodiments, the data stream may be encrypted prior to being encrypted further with the device-specific security key based on, for example, a simple XOR algorithm, a technique of adding a few bits of data, an Advanced Encryption Standard (AES) chained mode, a Cipher-Block Chaining (CBC) mode and/or a Triple Data Encryption Standard (Triple DES) algorithm. In one or more embodiments, the aforementioned standard techniques of encryption may also be used in conjunction with the device-specific security key to further encrypt the data stream, and such combinations are well within the scope of the exemplary embodiments. In one or more embodiments, the standard techniques of encryption may be, for example, 128 bit based, 192 bit based or 256 bit based. In one or more embodiments, the encryption schemes may be chosen based on the type of data in the data stream.

In one or more embodiments, the memory 204 may be an on-chip memory and/or an off-chip memory, or a virtual memory, as discussed above. In one or more embodiments, the external requests to the memory/storage device 204 may include, for example, a processor (e.g., Central Processing Unit (CPU)) initiated request to play a Digital Video Disc (DVD) media content or a processor initiated request to play a media content associated with a downloaded Video-On-Demand (VOD) stream. In one or more embodiments, the processor may be a part of the data processing device 200.

In one or more embodiments, when the data stream associated with the write data 222 request arrives at the data secure memory/storage control system 250, a snooper/header parser 212 may be provided to dynamically analyze (e.g., “snoop on”) the data stream. In one or more embodiments, the snooper/header parser 212 may be pre-programmed to “snoop on” the data stream, and to recognize different types of header formats. In one or more embodiments, the snooper/header parser 212 may be configured to automatically transmit the data stream to the encrypter 208 in the data secure memory/storage control system 250 upon recognition of the header formats associated with the data stream.

In one or more embodiments, the header formats may be auto-programmed or user defined. For example, in one or more embodiments, certain header formats may be pre-programmed in a data processing device 200 having a Digital Entertainment Content Ecosystem (DECE) compatible encryption scheme. In one or more embodiments, the snooper/header parser 212 may decide to automatically encrypt a data stream associated with a known content (e.g., Blu-ray™ content) or to not encrypt the data stream. In one or more embodiments, different types of data streams may be hard-coded into registers of the snooper/header parser 212 and/or user-programmed as part of the software. In one or more embodiments, the snooper/header parser 212 may be implemented in a Field-Programmable Gate Array (FPGA).

In one or more embodiments, encryption using the encrypter 208 and the security key generation/management block 206 may be bypassed, and the snooper/header parser 212 may directly transmit the data stream to the data multiplexer (Data MUX 214) configured to receive the output of the encrypter 208. In one or more embodiments, the decision to bypass the encryption by the encrypter 208 in conjunction with the security key generation/management block 206 may be automatic, and may be again based on the data header formats.

In an exemplary VOD system, the data stream may already be secure (e.g., through a security mechanism provided by the content provider), and further encryption may not be desirable by customers of a cable television provider offering the VOD streaming/download capability. Therefore, in one or more embodiments, the encryption by the encrypter 208 in conjunction with the security key generation/management block 206 may be bypassed. In one or more embodiments, the data stream may, however, be decrypted through the keys associated with the media content. In one example embodiment, a Blu-ray™ content may have associated keys that may be utilized during the decryption prior to rendering of the media content on a display unit. In one or more embodiments, the display unit may be a part of the data processing device 200.

In one or more embodiments, the data processing device 200 may have a bypass mode, whereby the data stream may directly be transmitted to Data MUX 214. In one or more embodiments, the bypass mode may be available through an external pin in, for example, an integrated circuit implementation of the data secure memory/storage control system 250, or through a programmable register configured to generate a Data MUX 214 signal inside the data secure memory/storage control system 250. In one or more embodiments, the bypass mode may be enabled/disabled through hardware and/or software for specific implementations, with no exposure to potential security threats.

In an exemplary embodiment, a software/device driver may be designed to activate a register to turn ON encryption every time a specific data stream arrives at the data secure memory/storage control system 250. In one or more embodiments, the bypass mode may, therefore, be turned OFF every time processing of the specific data stream is required. In one or more embodiments, an indicator (e.g., a bit) associated with the encryption may be turned OFF in the register following the completion of the encryption process.

In one or more embodiments, therefore, Data MUX 214 may be configured to have three data paths at the input thereof, viz., the path where the data stream is transmitted directly to Data MUX 214 without encryption, the path where the data stream, after being analyzed by the snooper/header parser 212, is transmitted to Data MUX 214 without encryption, and the path where the data stream, after being analyzed by the snooper/header parser 212, is transmitted to Data MUX 214 with encryption. In one or more embodiments, the snooper/header parser 212 may serve as an initial qualifier for the data stream. In one or more embodiments, the output of Data MUX 214 (i.e., one of the three inputs) may be transferred to the memory/storage device 204 through the memory/storage controller 202. In one or more embodiments, Data MUX 214 may also be interfaced with the security key generation/management block 206.

In one or more embodiments, therefore, a block of data may be secured in the memory/storage device 204. In one or more embodiments, in accordance with a read data 224 request, the security flag stored in the security key generation/management block 206 may be utilized to determine as to whether the block of data is secure and/or whether decryption is needed. In one or more embodiments, the data associated with the media content may be transmitted directly as the output through the data multiplexer (Data MUX 216) also configured to receive the output of the decryption by the decrypter 210 or to the decrypter 210 based on the security flag. Therefore, in one or more embodiments, blocks of the memory/storage device 204 may be secured based on data types.

In one example embodiment, the security key stored in the security key generation/management block 206 during the write data 222 process may be a 128/256 bit key. In one or more embodiments, supplemental data unique to the data write session may be written to the memory/storage device 204 along with the security key. In one or more embodiments, this supplemental data may be one or more extra bits or a word (e.g., a 32 bit word or, in general, an N-bit word, N≧2) unique to the data write session. In one or more embodiments, the supplemental data may serve as the security flag unique to the data write session. In one example implementation, only 128/256 data write sessions may be possible, and, therefore, there may be a maximum of 128/256 available blocks of data in the memory/storage device 204.

In one or more embodiments, during the read data 224 (i.e., memory/storage read) process, the supplemental data (e.g., security flag) in the secured block of data in the memory/storage device 204 may be utilized to initiate the decrypting process. In one or more embodiments, this may be possible through the provision of a comparator associated with the memory/storage controller 202 configured to compare the supplemental data (e.g., security flag) in the secured block of data in the memory/storage device 204 to the supplemental data (e.g., security flag) stored in the security key generation/management block 206. In one or more embodiments, as discussed above, the supplemental data may be stored in a non-volatile memory associated with the security key generation/management block 206. In one or more embodiments, the non-volatile memory may be a ROM.

In one or more embodiments, the comparator may constantly monitor the memory/storage read processes. In one or more embodiments, the interfacing of the security key generation/management block 206 with Data MUX 214 may provide a path for the successful execution of the aforementioned comparison.

As discussed above, in one or more embodiments, the supplemental data (e.g., security flag) may be unique to the data write session. In one or more embodiments, the uniqueness may also be based on the type of memory/storage device 204 (e.g., on-chip device, off-chip device, virtual memory/storage device) to which the data is written to. In one or more embodiments, the initial latency associated with the decision to secure the data stream may be alleviated in the long term through the transfer of data in the form of bursts.

In one or more embodiments, an optional security key exchange block 218 may be provided to allow for secure messaging between the subsystem including the data secure memory/storage control system 250 and other subsystems in the data processing device 200 and/or between the data processing device 200 and another similar device. In one or more embodiments, security keys may be exchanged through, for example, a scatter-gather mechanism, i.e., a mechanism based on a scatter-gather algorithm. In one or more embodiments, security keys may be exchanged between the devices through, for example, an exchange of indexes that may serve as an address look up for the security keys resident on both devices. For example, in one or more embodiments, a content key related to the media content associated with the data stream may be transmitted to the security key generation/management block 206 through the optional key exchange block 218. In one or more embodiments, a hardware/software access interface 220 (e.g., Joint Test Action Group (JTAG) interface) may be provided to access the security key generation/management block 206 for purposes not limited to programming the optional key exchange block 218, transferring data to the optional key exchange block 218, and debugging the optional key exchange block 218 (e.g., changing security keys).

In one or more embodiments, the data secure memory/storage control system 250, the memory/storage controller 202, and/or the memory/storage device 204 may be part of a System-on-a-chip (SoC). Therefore, in one or more embodiments, the optional key exchange block 218 may be provided to enable SoC designers to design secure messaging between subsystems of the same SoC and/or between the SoC and another device.

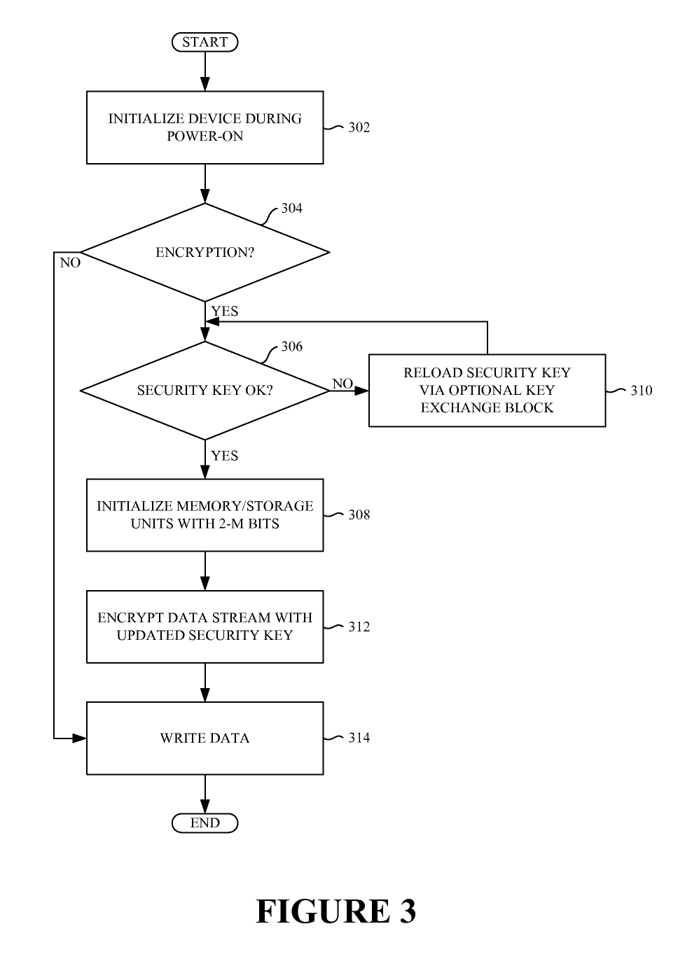

FIG. 3 shows a flowchart detailing the operations involved in a write data 222 process, according to one or more embodiments. In one or more embodiments, operation 302 may involve initializing the data processing device 200 during power-up (e.g., auto-initialization of the data processing device 200 during power-up). In one or more embodiments, as soon as a write data 322 request is received, the secure registers and the storage element (e.g., secure buffer, non-volatile memory) associated with the device-specific security key generated by the security key generation/management block 206 and the supplemental data (e.g., security flag) to be generated specific to the data write session including data associated with the media content may be initialized. In one or more embodiments, as discussed above, the storage element associated with the device-specific security key and the supplemental data may be a non-volatile memory (e.g., ROM, Electrically Erasable Programmable Read-Only Memory (EEPROM)) provided in the security key generation/management block 206.

In one or more embodiments, operation 304 may involve deciding as to whether encryption is needed or not, based on the data stream. In one or more embodiments, operation 304 may include a decision to be made by the snooper/header parser 212. In one or more embodiments, the decision to bypass the encryption performed by the encrypter 208 may be due to the bypass mode described above or due to the encryption being bypassed at the output of the snooper/header parser 212. In one or more embodiments, operation 314 may then involve writing the data associated with the media content directly to the memory/storage device 204 without encryption.

In one or more embodiments, operation 306 may involve deciding as to whether the security key generated by the security key generation/management block 206 is proper. In one or more embodiments, the device-specific security key may be used in conjunction with a content-specific security key, as discussed above. In one or more embodiments, when the security key is adjudged to be improper in operation 306, operation 310 may involve reloading the security key in the security key generation/management block 206 via the optional key exchange block 218. As discussed above, the hardware/software access interface 220 may be utilized to access the optional key exchange block 218.

In one or more embodiments, when the security key is adjudged to be proper in operation 306, operation 308 may involve initializing memory/storage circuits in the data processing device 200 associated with storing the security key with M bits, where M≧2. In one or more embodiments, the device-specific security key may be periodically refreshed, as discussed above. Therefore, in one or more embodiments, the security key generation/management block 206 may be updated with the newly generated device-specific security key.

In one or more embodiments, operation 312 may then involve encrypting the data (i.e., data stream, as discussed above) associated with the media content with the updated security key stored in the security key generation/management block 206. Finally, in one or more embodiments, operation 314 may involve writing the encrypted data to the memory/storage device 204, with the encrypted data transfer to the memory/storage device 204 being aided by the memory/storage controller 202.

Therefore, in one or more embodiments, the dynamic encryption of data associated with media content and the subsequent encrypted data transfer to the memory/storage device 204 may provide for secure data control in the data processing device 200. The media content processed in the data processing device 200, thus, may be protected against varied hacking attempts. In one or more embodiments, wherever memory/storage device 204 is vulnerable to hacking, the data secure memory/storage control system 250 may provide an extremely robust layer of additional security to the media content processed therein.

In one or more embodiments, as the security key generation also may be dynamic (e.g., security key may change every time during powering-on of the data processing device 200, security key may be periodically refreshed based on several factors), a potential hacker may be unable to obtain the unencrypted media content even when he/she figures out encryption algorithms associated with standard encryption techniques utilized in conjunction with the device-specific security key.

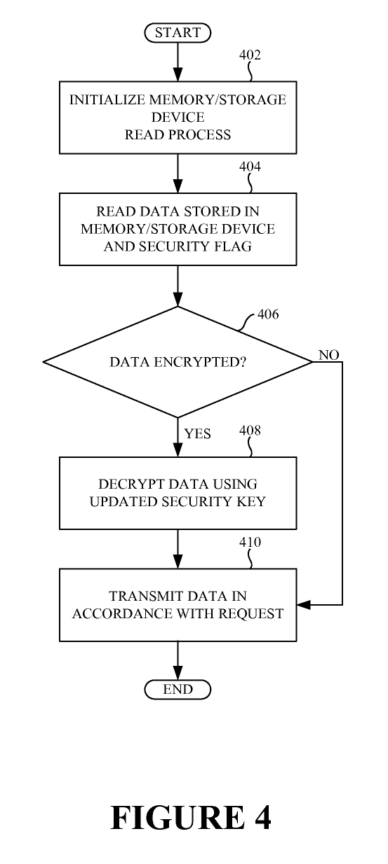

FIG. 4 shows a flowchart detailing the operations involved in a read data 224 process, according to one or more embodiments. In one or more embodiments, an external request may initiate a memory/storage device 204 read process in operation 402. In one or more embodiments, upon the memory/storage device 204 read process being initiated, the data stored in the memory/storage device 204 during the write process and, when applicable, the security flag exclusive to the data write session, may be read at the memory/storage controller 202 in operation 404.

In one or more embodiments, operation 406 may involve deciding as to whether the data read from the memory/storage device 204 is encrypted (i.e., secure) or not. In one or more embodiments, when the data is determined to be unencrypted at operation 406, the unencrypted data may be transmitted in accordance with the data read 224 request in operation 410. In one example embodiment, the data associated with the media content may be transmitted to be rendered on a display unit associated with the data processing device 200, in accordance with the data read 224 request.

In one or more embodiments, when the data is determined to be encrypted at operation 406 based on the security flag associated with the write session involved, the encrypted data may be decrypted at the decrypter 210 using the appropriate updated security key stored in the security key generation/management block 206 in operation 408. In one or more embodiments, a key lookup table may be maintained at the security key generation/management block 206, based on which a match for the security key associated with the encrypted data may be found. In one or more embodiments, decrypter 210 may, therefore, perform the decryption in association with the security key generation/management block 206. Then, in one or more embodiments, the decrypted data may be transmitted in accordance with the data read 224 request in operation 410. In the example embodiment discussed above, the data associated with the media content may be transmitted to be rendered on the display unit associated with the data processing device 200, in accordance with the data read 224 request.

In one or more embodiments, the security vulnerabilities associated with a memory/storage device 204 data securing technique based on storing starting and ending addresses of blocks of data in the memory/storage device 204 to be secured therein may be eliminated. In one or more embodiments, the determination of a decryption requirement for data read from the memory/storage device 204 may be done based on a mere comparison of a few bits of the security flag unique to the data write session involved.

In one or more embodiments, a pre-existing security mechanism may be determined for a vulnerability thereof, following which the additional security layer may be provided. In one or more embodiments, the additional security layer may be provided irrespective of the amount of vulnerability present in the pre-existing security mechanism. In one or more embodiments, the uniqueness of the dynamically generated device-specific security key may render it impossible even for the content provider/device designer to control generation of the device-specific security key. In one or more embodiments, the unavailability of address information (e.g., read address) associated with secured blocks of data in the memory/storage device 204, as discussed above, may provide for a near-foolproof security mechanism.

In one or more embodiments, the data secure memory/storage control system 250 may, therefore, serve as a stand-alone security engine associated with the memory/storage controller 202. In one or more embodiments, the stand-alone security engine (i.e., the data secure memory/storage control system 250) may also be a part of the memory/storage controller 202. In other words, in one or more embodiments, the memory/storage controller 202 may be integrated with the security engine. In one or more embodiments, the “self-contained” aspect of the data secure memory/storage control system 250 may be operating system/device independent.

In one or more embodiments, the dynamic encryption/decryption processes, aided by the provision of bypass logic associated with memory/storage device 204 read/write processes, may have minimal latency associated therein. In one or more embodiments, the security key generation/management block 206 may include secure registers to accommodate security key updates. In one or more embodiments, the flexibility of bit-selection (e.g., allowing M bit storage, M≧2) associated with data encryption/decryption may allow for flexibility in memory/storage device 204 protection. As discussed above, in one or more embodiments, the data secure memory/storage control system 250 may be applicable to a variety of memory/storage device 204 types.

In one or more embodiments, the data secure memory/storage control system 250 may integrate with and conform to a variety of memory/storage controller 202 standards and interfaces. In one or more embodiments, the dynamic security key update method may keep track of prior memory/storage device write processes and security keys associated therein. In one or more embodiments, this may provide for intelligent memory/storage device content updates. In one or more embodiments, the data secure memory/storage control system 250 may be compatible with both “hard” reset and “soft” reset schemes of the data processing device 200.

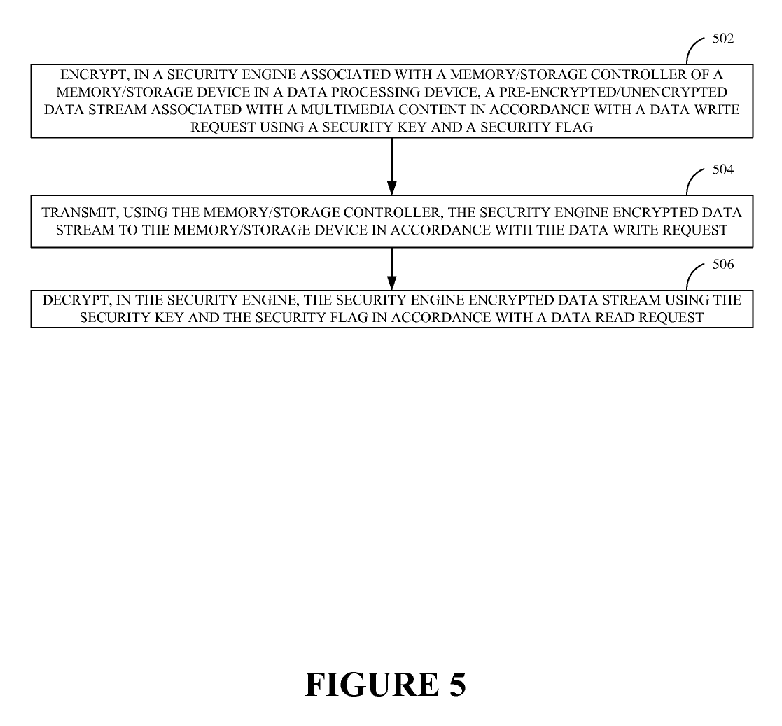

FIG. 5 shows a process flow diagram detailing the operations involved in a method of securely encrypting/decrypting a data stream, according to one or more embodiments. In one or more embodiments, operation 502 may involve encrypting, in a security engine (e.g., data secure memory/storage control system 250) associated with a memory/storage controller 202 of a memory/storage device 204 in a data processing device 200, a pre-encrypted/unencrypted data stream associated with a multimedia content in accordance with a data write request using a security key and a security flag.

In one or more embodiments, the data write request may be a request to transfer the pre-encrypted/unencrypted data stream to the memory/storage device 204. In one or more embodiments, the security key may be configured to uniquely identify the data processing device 200 during each data write session, and the security flag may be configured to uniquely identify each data write session. In one or more embodiments, the aforementioned encryption may be performed during a secure mode of operation.

In one or more embodiments, operation 504 may involve transmitting, using the memory/storage controller 202, the encrypted data stream to the memory/storage device 204 in accordance with the data write request. In one or more embodiments, operation 506 may then involve decrypting, in the security engine associated with the memory/storage controller 202, the encrypted data stream using the security key and the security flag utilized during the data write session associated with the encryption of the pre-encrypted/unencrypted data stream and the transfer of the encrypted data stream to the memory/storage device 204 in accordance with a data read request to read the encrypted data stream stored in the memory/storage device 204.

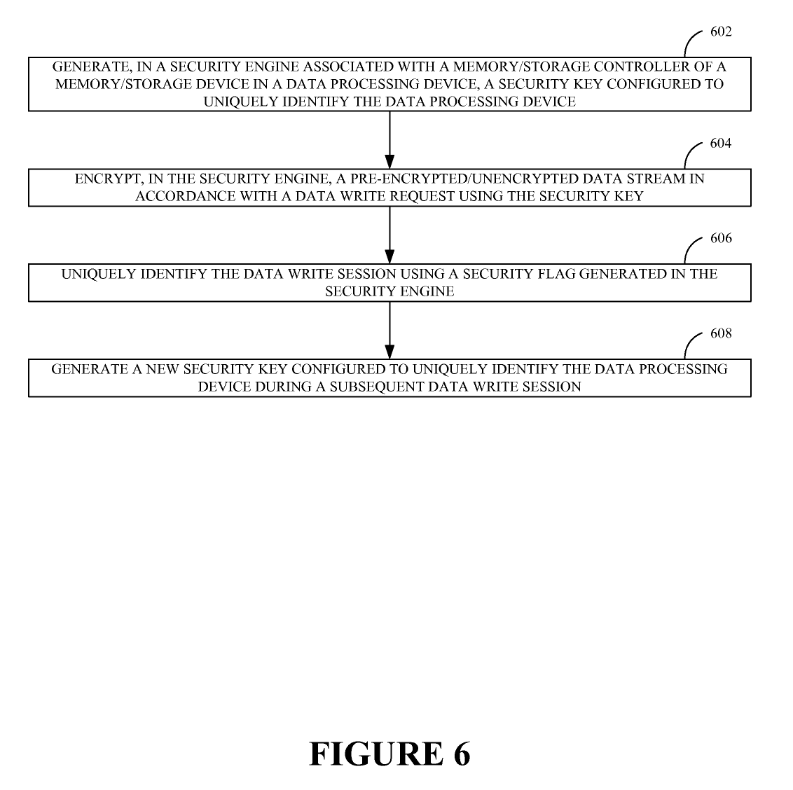

FIG. 6 shows a process flow diagram detailing the operations involved in a data secure memory/storage control, according to one or more embodiments. In one or more embodiments, operation 602 may involve generating, in a security engine (e.g., data secure memory/storage control system 250) associated with a memory/storage controller 202 of a memory/storage device 204 in a data processing device 200, a security key configured to uniquely identify the data processing device 200.

In one or more embodiments, operation 604 may involve encrypting, in the security engine associated with the memory/storage controller 202, a pre-encrypted/unencrypted data stream associated with a multimedia content in accordance with a data write request to transfer the pre-encrypted/unencrypted data stream to the memory/storage device 204 using the security key configured to uniquely identify the data processing device 200 during a secure mode of operation.

In one or more embodiments, operation 606 may involve uniquely identifying the data write session associated with the data write request using a security flag generated in the security engine to enable subsequent decryption of the encrypted data stream using the security key and the security flag in accordance with a data read request to the memory/storage device 204. In one or more embodiments, operation 608 may involve generating a new security key configured to uniquely identify the data processing device 200 during a subsequent data write session.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium).

In addition, it will be appreciated that the various operations, processes, and methods disclosed herein may be embodied in a machine-readable medium and/or a machine accessible medium compatible with a data processing system (e.g., a computer device), and may be performed in any order (e.g., including using means for achieving the various operations). Accordingly, the specification and drawings are to be regarded in an illustrative rather than a restrictive sense.

What is claimed is:

1. A method comprising:
encrypting, in a security engine associated with one of a memory controller and a storage controller configured to control a corresponding one of a memory and a storage device in a data processing device, one of a pre-encrypted and an unencrypted data stream associated with a multimedia content in accordance with a data write request to transfer the one of the pre-encrypted data stream and the unencrypted data stream to the corresponding one of the memory and the storage device using a security key configured to uniquely identify the data processing device during each data write session and a security flag configured to uniquely identify each data write session during a secure mode of operation;
transmitting, using the one of the memory controller and the storage controller, the security engine encrypted data stream to the corresponding one of the memory and the storage device in accordance with the data write request; and
decrypting, in the security engine associated with the one of the memory controller and the storage controller, the security engine encrypted data stream using the security key and the security flag utilized during the data write session associated with the encryption of the one of the pre-encrypted and the unencrypted data stream and the transfer of the security engine encrypted data stream to the corresponding one of the memory and the storage device in accordance with a data read request to read the security engine encrypted data stream stored in the corresponding one of the memory and the storage device.

2. The method of claim 1, further comprising storing the security key configured to uniquely identify the data processing device and the security flag configured to uniquely identify the data write session in the security engine to enable utilization of the security key and the security flag during decryption of the security engine encrypted data stream.

3. The method of claim 1, wherein the security key is based on a random number generator within the security engine.

4. The method of claim 1, further comprising at least one of:
generating a new security key configured to uniquely identify the data processing device each time the data processing device is powered on; and
dynamically refreshing the security key configured to uniquely identify the data processing device based on at least one of a data processing device dependent parameter and a data write cycle performed on the data processing device.

5. The method of claim 1, wherein the data processing device is one of a Personal Computer (PC), a mobile phone, and a set-top box.

6. The method of claim 1, wherein the memory controller is one of a Double Data Rate-1 (DDR1) controller, a Double Data Rate-2 (DDR2) controller, a Double Data Rate-3 (DDR3) controller, and a Rambus® controller.

7. The method of claim 1, wherein the memory is one of an on-chip memory, an off-chip memory, and a virtual memory, and wherein the storage device is one of a hard disk drive, a flash disk drive, and a virtual storage device.

8. The method of claim 1, wherein the memory is one of a Static Random Access Memory (SRAM), a Dynamic Random Access Memory (DRAM), a Non-Volatile Random Access Memory (NVRAM), a cache memory, a DDR memory, a register file, a Content Comparator Memory (CCM), a Closely Coupled Memory, a data memory, and a First In First Out (FIFO) memory.

9. The method of claim 1, wherein the pre-encrypted data stream is pre-encrypted based on at least one of an XOR algorithm, an Advanced Encryption Standard (AES) chained mode, a Cipher-Block Chaining (CBC) mode, and a Triple Data Encryption Standard (Triple DES) algorithm.

10. The method of claim 1, further comprising utilizing a standard encryption scheme in conjunction with the security key and the security flag during the encryption process.

11. The method of claim 1, further comprising initiating the data write request and the data read request through a processor in the data processing device.

12. The method of claim 1, wherein the multimedia content is at least one of a text content, an image content, an audio content, and a video content.

13. The method of claim 1, further comprising:
pre-programming data header formats associated with the multimedia content into the security engine;
dynamically analyzing the data stream at the security engine to recognize the pre-programmed data header formats in the data stream; and
one of transmitting the data stream to an encryption block of the security engine to encrypt the data stream and directly transmitting the data stream to the corresponding one of the memory and the storage device through the one of the memory controller and the storage controller based on the recognition of the pre-programmed data header formats associated with the multimedia content in the data stream.

14. The method of claim 1, further comprising directly transmitting the pre-encrypted data stream to the corresponding one of the memory and the storage device through the one of the memory controller and the storage controller without encryption at the security engine during a bypass mode of operation.

15. The method of claim 1, wherein the security flag is one of a plurality of bits and an N-bit word unique to the data write session, and wherein N≧2.

16. The method of claim 1, further comprising exchanging a security key to be utilized during encryption through a security key exchange block provided in the security engine.

17. The method of claim 1, further comprising providing the one of the memory controller and the storage controller and the security engine on a System-on-a-chip (SoC).

18. The method of claim 1, further comprising rendering the multimedia content associated with the decrypted data stream on a display unit associated with the data processing device.

19. The method of claim 1, further comprising maintaining a key lookup table at the security engine to enable location of a match for the security key associated with the security engine encrypted data stream stored in the corresponding one of the memory and the storage device during decryption of the security engine encrypted data stream.

20. The method of claim 2, further comprising comparing the security flag associated with the security engine encrypted data stream stored in the corresponding one of the memory and the security device to the security flag stored in the security engine at the one of the memory controller and the storage controller.

21. The method of claim 4, further comprising updating the security engine based on at least one of the new generation and the periodic refreshment of the security key.

22. The method of claim 14, further comprising at least one of enabling and disabling the bypass mode through one of an external pin in an integrated circuit implementation of the security engine and a programmable register inside the security engine.

23. The method of claim 16, further comprising transmitting a content key related to the multimedia content through the security key exchange block.

24. A method comprising:
generating, in a security engine associated with one of a memory controller and a storage controller configured to control a corresponding one of a memory and a storage device in a data processing device, a security key configured to uniquely identify the data processing device;
encrypting, in the security engine associated with the one of the memory controller and the storage controller, one of a pre-encrypted and an unencrypted data stream associated with a multimedia content in accordance with a data write request to transfer the one of the pre-encrypted and the unencrypted data stream to the corresponding one of the memory and the storage device using the security key configured to uniquely identify the data processing device during a secure mode of operation;
uniquely identifying the data write session associated with the data write request using a security flag generated in the security engine to enable subsequent decryption of the security engine encrypted data stream using the security key and the security flag in accordance with a data read request to the corresponding one of the memory and the storage device; and
generating a new security key configured to uniquely identify the data processing device during a subsequent data write session.

25. The method of claim 24, further comprising storing the security key configured to uniquely identify the data processing device and the security flag configured to uniquely identify the data write session in the security engine to enable utilization of the security key and the security flag during decryption of the security engine encrypted data stream.

26. The method of claim 24, further comprising initiating the data write request and the data read request through a processor in the data processing device.

27. The method of claim 24, further comprising directly transmitting the pre-encrypted data stream to the corresponding one of the memory and the storage device through the one of the memory controller and the storage controller without encryption at the security engine during a bypass mode of operation.

28. A data processing device comprising:
one of a memory and a storage device;
one of a memory controller and a storage controller configured to control a data read request and a data write request to the corresponding one of the memory and the storage device; and
a security engine associated with the one of the memory controller and the storage controller, the security engine being configured to:
encrypt one of a pre-encrypted data stream and an unencrypted data stream associated with a multimedia content in accordance with the data write request to transfer the one of the pre-encrypted data stream and the unencrypted data stream to the corresponding one of the memory and the storage device based on a security key and a security flag generated therein, the security key being configured to uniquely identify the data processing device during each data write session and the security flag being configured to uniquely identify each data write session, and
decrypt the security engine encrypted data stream using the security key and the security flag utilized during the data write session associated with the encryption of the one of the pre-encrypted data stream and the unencrypted data stream and the transfer of the encrypted data stream to the corresponding one of the memory and the storage device in accordance with the data read request to read the security engine encrypted data stream stored in the corresponding one of the memory and the storage device.

29. The data processing device of claim 28, wherein the security key configured to uniquely identify the data processing device and the security flag configured to uniquely identify the data write session are stored in the security engine to enable utilization thereof during decryption of the security engine encrypted data stream.

30. The data processing device of claim 28, wherein the memory controller is one of a DDR3 controller, a DDR2 controller, a DDR1 controller, and a Rambus® memory controller.

31. The data processing device of claim 28, wherein the memory is one of an on-chip memory, an off-chip memory and a virtual memory, and wherein the storage device is one of a hard disk drive, a flash disk drive, and a virtual storage device.

32. The data processing device of claim 28, wherein the memory is one of an SRAM, a DRAM, an NVRAM, a cache memory, a DDR memory, a register file, a CCM, a Closely Coupled Memory, a data memory, and a FIFO memory.

33. The data processing device of claim 28, further comprising a processor to initiate the data write request and the data read request.

34. The data processing device of claim 28, wherein the multimedia content is at least one of a text content, an image content, an audio content, and a video content.

35. The data processing device of claim 28, further comprising a display unit configured to render the multimedia content associated with the decrypted data stream.
